(19) United States
(12) Patent Application Publication
(10) Pub. No.: US 2007/0195194 A1
(43) Pub. Date: Aug. 23, 2007

(54) Image format conversion

(75) Inventor: Marc Joseph Rita Op De Beeck, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,444

(22) PCT Filed: Dec. 6, 2004
(86) PCT No.: PCT/IB04/52670

§ 371 Date: Jun. 14, 2006

(30) Foreign Application Priority Data
Dec. 17, 2003 (EP) 03104753.3

(51) Int. Cl. H04N 7/01

(52) U.S. Cl. 348/445; 348/441

(57) ABSTRACT

An image conversion unit (400,700) for converting an input image with an input aspect ratio into an output image with an output aspect ratio being different from the input aspect ratio, is disclosed. The image conversion unit (400,700) comprises segmentation means (402) for segmentation of the input image on basis of pixel values of the input image, resulting in a first group of connected pixels forming a first input segment (310) which represents a first object and a second group of connected pixels forming a second input segment (306) which represents a second object; and scaling means (404) for scaling the first input segment (310) in a first direction with a location dependent scaling factor into a first output segment (320) of the output image and for scaling the second input segment (306) in the first direction with a constant scaling factor into a second output segment (316) of the output image.

The invention relates to an image conversion unit for converting an input image with an input aspect ratio into an output image with an output aspect ratio being different from the input aspect ratio.

The invention further relates an image display apparatus comprising:

a receiver for receiving an input image;

an image conversion unit as mentioned above; and

a display device for displaying the output image.

The invention further relates to a method of converting an input image with an input aspect ratio into an output image with an output aspect ratio being different from the input aspect ratio.

The invention further relates to a computer program product to be loaded by a computer arrangement, comprising instructions to convert an input image with an input aspect ratio into an output image with an output aspect ratio being different from the input aspect ratio.

An embodiment of the image display apparatus of the kind described in the opening paragraph is known from U.S. Pat. No. 5,461,431.

Several aspect ratios of television standards exist. Nowadays, the 16:9 widescreen aspect ratio is one of these. But still many TV-broadcasts are in 4:3 aspect ratio. Hence some form of aspect ratio conversion is necessary. Some common methods and their drawbacks for conversion from 4:3 to 16:9 are:

adding black bars at the sides. This gives no real 16:9 result;

stretching the image horizontally and vertically. This means that in many cases information at top and bottom is lost. However the approach is perfect when the 4:3 material is actually 16:9 with black bars at the top and bottom, which is called “letterbox” mode.

stretching only horizontally. The result is that all objects in the images are distorted.

In U.S. Pat. No. 5,461,431 it is disclosed that the images are stretched horizontally with a non-uniform, i.e. location dependent, scaling factor. This is called a “panoramic stretch”. The effect is that objects near the side are more distorted than in the center. The “panoramic stretch” is acceptable for some images. This can be quite annoying.

It is an object of the invention to provide an image conversion unit of the kind described in the opening paragraph which provides a perceptually improved output image, compared to an image conversion unit according to the prior art.

This object of the invention is achieved in that the image conversion unit comprises:

segmentation means for segmentation of the input image on basis of pixel values of the input image, resulting in a first group of connected pixels forming a first input segment which represents a first object and a second group of connected pixels forming a second input segment which represents a second object; and

scaling means for scaling the first input segment in a first direction with a location dependent scaling factor into a first output segment of the output image and for scaling the second segment in the first direction with a constant scaling factor into a second output segment of the output image.

The image conversion unit according to the invention is arranged to perform the scaling of the input image on basis of the actual image content. The scaling is not always fixed or determined by the spatial coordinates of the pixels. Instead of that, the scaling depends on content analysis of the input image. A part of the content analysis is segmentation on basis of the pixel values of the input image. With pixel values is meant luminance or color. The segmentation is substantially performed by means of the segmentation means of the image conversion unit. Alternatively, the segmentation means are arranged to perform the segmentation on basis of segmentation results which are provided externally. The various input segments are scaled on basis of the segmentation. That means that, e.g. a first input segment is scaled in a first direction with a location dependent scaling factor as is known as “panoramic stretch”, while a second input object is scaled in the first direction with a constant scaling factor. In other words, the scaling is related to objects and not to pixels.

An embodiment of the conversion unit according to the invention, further comprises object tracking means for tracking the second object by establishing that a further input segment in a further input image which belongs to a sequence of video images to which the input image also belongs, corresponds to the second input segment, and the scaling means being arranged to scale the further input segment into a further output segment with the constant scaling factor. An advantage of the embodiment is the temporal stability. An object is represented by means of a series of output segments which have substantially the same size, independent of their position in the output image.

An embodiment of the image conversion unit according to the invention, further comprises depth ordering means being arranged to establish a depth order between the first input segment and the second input segment. An advantage of this embodiment according to the invention is that it is arranged to distinguish between the input segments. For example, it is arranged to determine that the second input segment is located in front of the first input segment. The first input segment corresponds to the background and the second input segment corresponds to a foreground object. This embodiment of the image conversion unit is arranged to scale the foreground object, i.e. the second input segment, with a substantially constant factor. A typical foreground “object” is an actor. This embodiment of the image conversion unit prevents that an input segment corresponding to an actor, who is on the foreground, is scaled such that the actor looks asymmetrically distorted.

Preferably the depth ordering means are based on one of a set of depth cues comprising: occlusion, relative image sharpness, color, size of segments. See e.g. “A novel approach to depth ordering in monocular image sequences”, by L. Bergen and F. Meyer, in IEEE Conference On Computer Vision & Pattern Recognition (CVPR), 2000, Vol. 2, pp. 536-541

An embodiment of the image conversion unit according to invention comprises merging means for merging the first output segment and the second output segment resulting in overwriting a part of the pixel values of the first output segment with pixel values of the second output segment. The scaling of a first input segment is independent of the scaling of the second input segment. As a result, a part of the first output segment and the second output segment spatially overlap. This embodiment of the image conversion unit is arranged to overwrite the pixel values of the first output segment with pixel values of the second output segment.

An embodiment of the image conversion unit according to the invention, comprises input means for accepting user input and scaling determining means for determining the constant scaling factor on basis of the user input. Is user can provide information to the image conversion unit about the required scaling. For instance the user can indicated that an input segment corresponding to foreground object is scaled with a relatively high scaling factor compared to an output segment corresponding to the background. The result is that it looks as if the foreground object is closer to the viewer, i.e. user.

In an embodiment of the image conversion unit according to the invention, the input aspect ratio and the output aspect ratio are substantially equal to values of elements of the set of standard aspect ratios being used in television. Possible values are e.g. 4:3; 16:9 and 14:9.

It is a further object of the invention to provide an image display apparatus of the kind described in the opening paragraph which provides a perceptually improved output image, compared to an image display apparatus according to the prior art.

This object of the invention is achieved in that the image conversion unit comprises:

segmentation means for segmentation of the input image on basis of pixel values of the input image, resulting in a first group of connected pixels forming a first input segment which represents a first object and a second group of connected pixels forming a second input segment (306) which represents a second object; and

scaling means for scaling the first input segment in a first direction with a location dependent scaling factor into a first output segment of the output image and for scaling the second segment in the first direction with a constant scaling factor into a second output segment of the output image.

It is a further object of the invention to provide a method of the kind described in the opening paragraph which provides a perceptually improved output image, compared to a method according to the prior art.

This object of the invention is achieved in that the method comprises:

segmentation of the input image on basis of pixel values of the input image, resulting in a first group of connected pixels forming a first input segment which represents a first object and a second group of connected pixels forming a second input segment (306) which represents a second object; and

scaling the first input segment in a first direction with a location dependent scaling factor into a first output segment of the output image and for scaling the second segment in the first direction with a constant scaling factor into a second output segment of the output image.

It is a further object of the invention to provide a computer program product of the kind described in the opening paragraph which provides a perceptually improved output image, compared to a computer program product according to the prior art.

This object of the invention is achieved in that the computer program product, after being loaded, provides said processing means with the capability to carry out:

segmentation of the input image on basis of pixel values of the input image, resulting in a first group of connected pixels forming a first input segment which represents a first object and a second group of connected pixels forming a second input segment (306) which represents a second object; and

scaling the first input segment in a first direction with a location dependent scaling factor into a first output segment of the output image and for scaling the second segment in the first direction with a constant scaling factor into a second output segment of the output image.

Modifications of the image conversion unit and variations thereof may correspond to modifications and variations thereof of the method and of the image display apparatus described.

These and other aspects of the image conversion unit, of the method and of the image display apparatus according to the invention will become apparent from and will be elucidated with respect to the implementations and embodiments described hereinafter and with reference to the accompanying drawings, wherein:

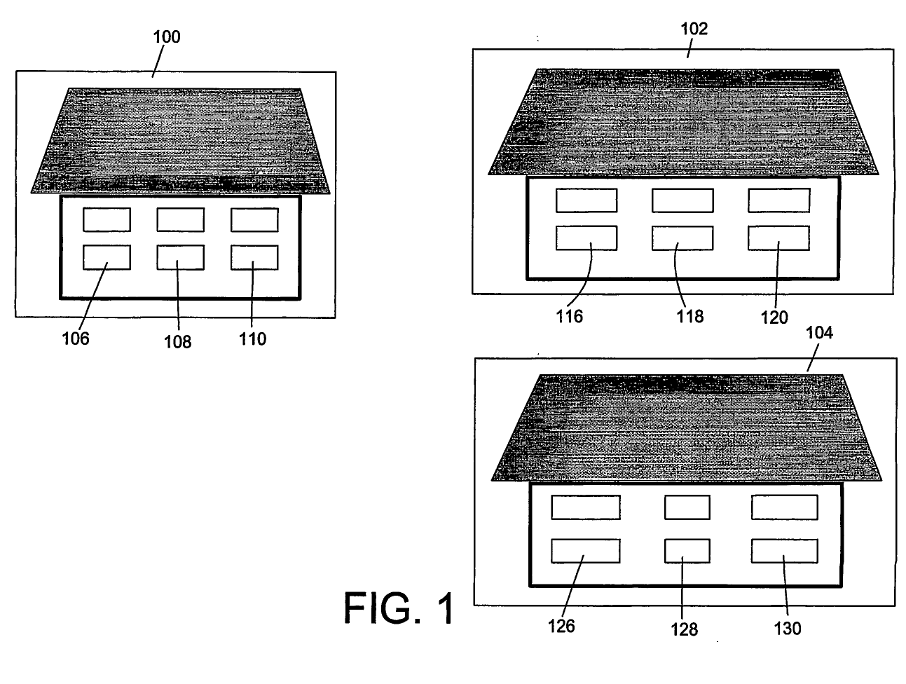

FIG. 1 schematically shows the effect of scaling in the first direction, according to the prior art;

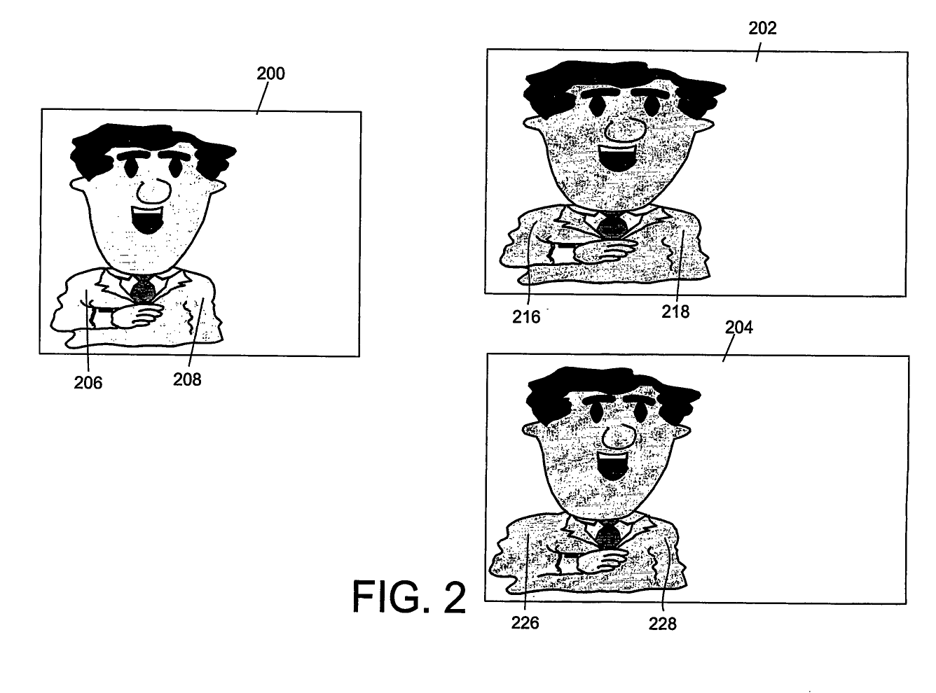

FIG. 2 schematically shows the effect of scaling in the first direction, according to the prior art, for another input image;

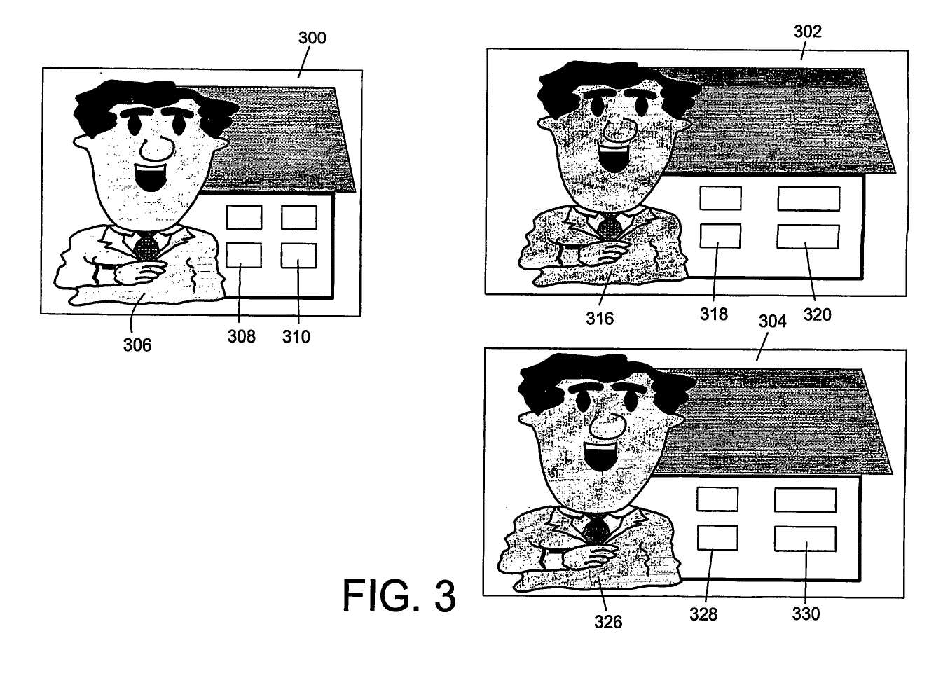

FIG. 3 schematically shows the effect of scaling in the first direction, according to the invention;

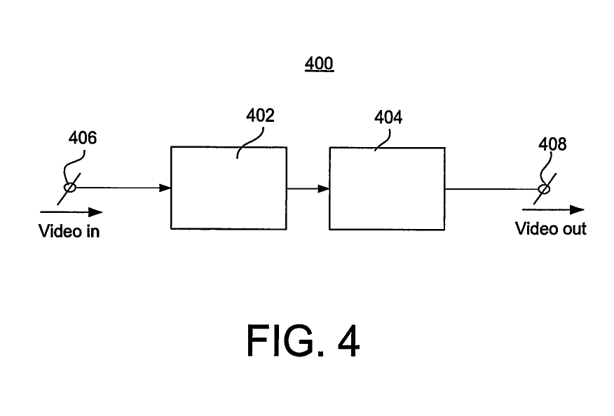

FIG. 4 schematically shows an embodiment of the image conversion unit according to the invention;

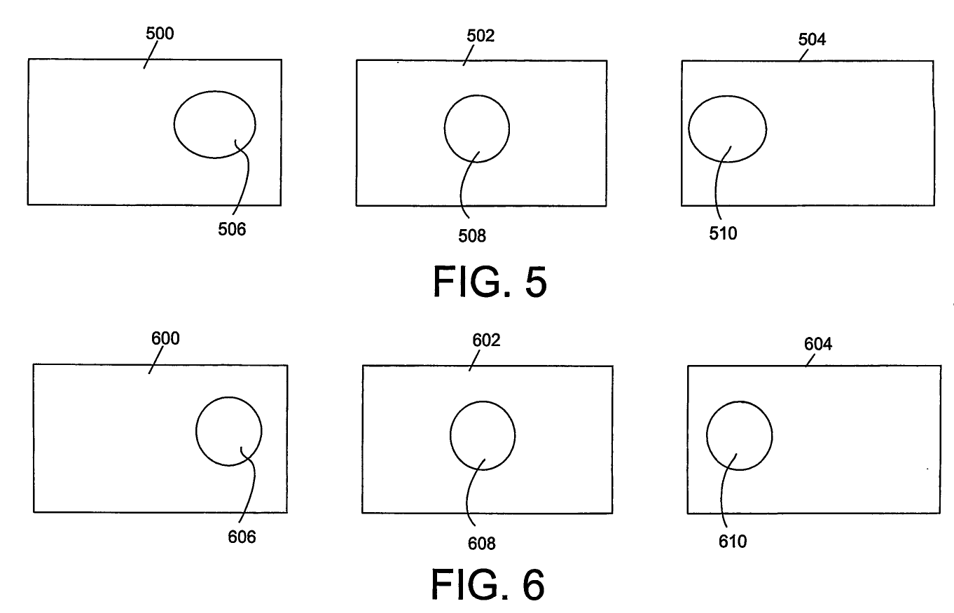

FIG. 5 schematically shows a series of output images which are scaled on basis of a method according to the prior art;

FIG. 6 schematically shows a series of output images which are scaled on basis of a method according to the invention;

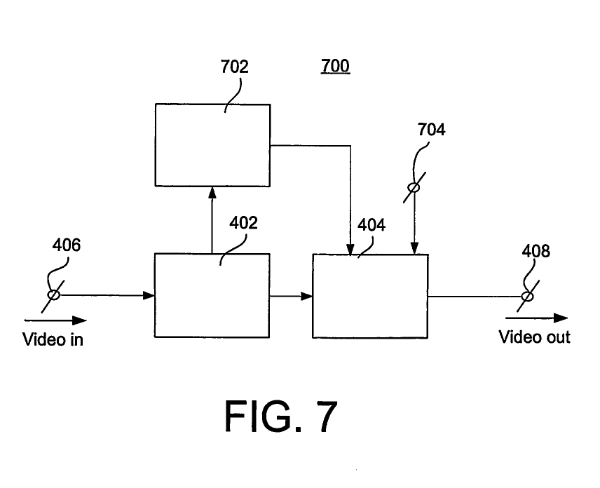

FIG. 7 schematically shows an embodiment of the image conversion unit according to the invention, comprising a tracking unit; and

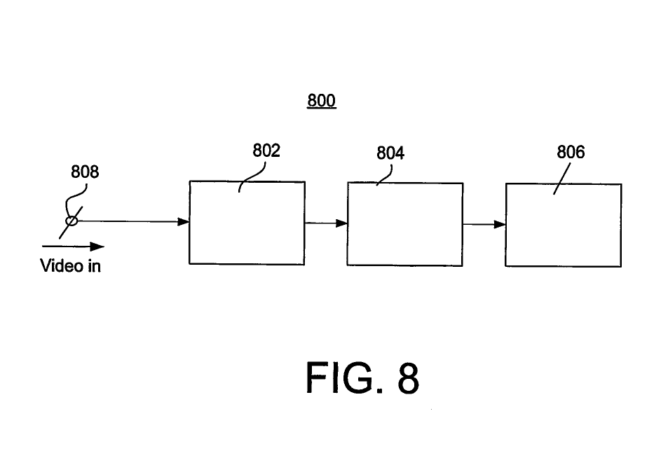

FIG. 8 schematically shows an image display apparatus according to the invention.

Corresponding reference numerals have the same meaning in all of the Figs.

FIG. 1 schematically shows the effect of scaling in the first direction, according to the prior art. FIG. 1 shows one input image 100 and two output images 102, 104. The input image 100 has an input aspect ratio of 4:3. The output images 102, 104 have an output aspect ratio of 16:9. In order to convert the input image 100 into one of the output images at least a scaling in a first direction, typically the horizontal direction is required. The first output image 102 is based on a linear scaling, i.e. with a constant scaling factor, of the input image 100. As can be seen, the picture of the house as shown in the input image 100 comprises a number of representations of windows 106, 108, 110 having the same width. The same house, after scaling, is represented by the first output image 102. Now, the representations of the windows 116, 118, 120 are wider than the corresponding representations of windows 106, 108, 110, respectively. However, the representations of the windows 116, 118, 120 have mutually the same width. That means that the scaling in the horizontal direction is independent of the spatial location of the representations of the windows 106, 108, 110.

Looking at the second output image 104, the effect of “panoramic stretch” can be observed. The second output image 104 represents the same house as shown in the input image 100. The representations of the windows 126, 128, 130 of the second output image 104 do not have mutually equal sizes, although they correspond to the representations of the windows 106, 108, 110 of the input image, respectively. The scaling in the horizontal direction is dependent on the spatial location of the representations of the windows 106, 108, 110. A first one of these representations of the windows 108 which is located nearby the centre of the image 100 is hardly enlarged. However, two other representations of the windows 106 and 110, being located relatively far from the centre of the image 100, are relatively much stretched in horizontal direction resulting into the windows 126 and 130, respectively.

FIG. 2 schematically shows the effect of scaling in the first direction, according to the prior art, for another input image 200. The input image 200 with an input aspect ratio of 4:3 shows a reporter. The first output image 202 shows the same reporter. The first output image 202 has been achieved by stretching the input image 200 in the horizontal direction with a constant scaling factor. The representation of the reporter has substantially changed. It looks as if the reporter has become relatively thick. The second output image 204 also shows the same reporter. The second output image 202 has been achieved by stretching the input image 200 in the horizontal direction with a spatial dependent scaling factor. Now the representation of the reporter has not only become wider, but it also looks as if the reporter has been deformed. The representations of the shoulders 206, 208 of the reporter in the input image 200 are substantially mutually equal in size. However, the representations of the shoulders 226, 228 of the reporter in the output image 204 differ relatively much in size. It looks as if the right shoulder 226 is much bigger than the left shoulder 228. This type of deformation can be quite annoying.

FIG. 3 schematically shows the effect of scaling in the first direction, according to the invention. The input image 300, having an input aspect ratio of 4:3 represents a reporter 306 in the foreground and a house in the background. The first output image 302 is achieved by scaling the input image 300 by means of the method according to the invention. The first output image 302 represents the same reporter 316 as can be seen in the input image 300. Notice that the size, i.e. the width of the representation 316 of the reporter in the first output image 302 and the width of the representation 306 of the reporter in the input image 300 are substantially mutually equal. However, by comparing the sizes of the representations of the windows 308, 310 of the input image 300 with the size of the representations of the windows 318, 320, respectively, the non-linear scaling of the background can be observed. See also the description in connection to FIG. 2 related to the non-linear scaling. With non-linear scaling is meant that the scaling is location dependent.

The second output image 304 is also achieved by scaling the input image 300 by means of the method according to the invention. The background, comprising the house with a number of representations of windows 308, 310 is scaled by means of a location dependent scaling in the horizontal direction, resulting into the house with the representations of the windows 328, 330, respectively. The representation 306 of the reporter is scaled with a constant scaling factor. The consequence of this approach is that the scaling is symmetrical for the object. Notice that a typical “panorama stretch” is symmetrical relative to the centre of the image and hence independent of the objects which are represented by the image. Besides scaling in the horizontal direction also a scaling, i.e. enlargement, in the vertical direction is performed. As a result, the representation 326 of the reporter is hardly distorted. An additional effect of this enlargement is that the reporter seems to be closer to the viewer compared with the input image 300.

FIG. 4 schematically shows the image conversion unit 400 according to the invention. The image conversion unit 400 is provided with a video input signal representing a series of input images, at its input connector 406 and is arranged to provide a video output signal representing a series of output images at its output connector 408. The image conversion unit 400 is arranged to convert a first one 300 of the input images with an input aspect ratio into a first 302 of the output images with an output aspect ratio being different from the input aspect ratio. The image conversion unit 400 comprises:

a segmentation unit 402 for segmentation of the first 300 of the input images is on basis of pixel values of the input images. The result of the segmentation is a first group of connected pixels forming a first input segment 310 which represents a first object and a second group of connected pixels forming a second input segment (306) 306 which represents a second object; and

a scaling unit 404 for scaling the first input segment 310 in a first direction with a location dependent scaling factor into a first output segment 320 of the first one 302 of the output images and for scaling the second segment 306 in the first direction with a constant scaling factor into a second output segment 316 of the first 302 of the output images.

As said above, a deformation of a representation of a person can be quite annoying. Preferably the image conversion unit 400 according to the invention is arranged to deal with representations of persons in a special way, i.e. preventing distortions. Recognition of the representations of persons is important to achieve that. In the article “Face detection: a survey”, by B. L. E. Hjelmas, in Computer Vision and Image Understanding, vol. 83, pp. 236-274, 2001, several techniques for face detection are disclosed. Most of these can be applied in the image conversion unit 400 according to the invention to determine which parts of the image should be scaled with a constant scaling factor.

Another important aspect is detection of background and foreground objects. Preferably, representations of foreground objects are not deformed by the scaling, while a deformation of the background is not necessarily a problem. The following articles describe how depth ordering of objects can be achieved. These articles also refers to appropriate segmentation techniques. “3D structure from 2D motion”, by T. Jebara, A. Azarbayejani and A. Pentland, in IEEE Signal Processing Magazine, pp. 66-84, May 1999. “Dense structure from motion: an approach based on segment matching”, by F. E. Ernst, P. Wilinski and K. van Oververld, in Proceedings ECCV, LNCS 2531, pp 11/217-11/231 Copenhagen, 2002 Springer. “Edge tracking for motion segmentation and depth ordering”, by P. Smith, T. Drummond, and R. Cipolla, in Proceedings 10th British Machine Vision Conference, Vol. 2, pp. 369-378, September 1999.

FIG. 5 schematically shows a series of output images 500, 502, 504 which are scaled on basis of a method according to the prior art. The output images 500, 502, 504 are based on a series of input images each representing a moving ball which is substantially circular. However, it can be clearly seen that the ball is not represented as a round image segment. Instead of that a first one of the output images 500 shows an oval segment 506 and also a third one of the output images 504 shows another oval segment 510. Only a second one of the output images 502 shows a segment 508 which is substantially circular. The reason of the deformations is the “panoramic stretch”, but as explained above in connection with FIG. 1.

FIG. 6 schematically shows a series of output images 600, 602, 604 which are scaled on basis of a method according to the invention. These output images 600, 602, 604 are based on the same series of input images which are used to make the series of output images 500, 502, 504 as depicted in FIG. 5. The segments 606, 608, 610 are all substantially circular. Besides that they have substantially mutually equal sizes. This series of output images is provided by the image conversion unit 700 as described in connection with FIG. 7.

FIG. 7 schematically shows an embodiment of the image conversion unit 700 according to the invention, comprising a tracking unit 702. An important aspect of this embodiment is the time consistent scaling. That means that the scaling of a series of corresponding input segments is performed by means of a single constant scaling factor. The tracking unit 702 is arranged to determine the relation between input segments in respective input images. Determining relations between input segments is generally known as “object tracking”. An important aspect of this embodiment according to the invention is that it is arranged to combine the object tracking with scaling.

The image conversion unit 700 comprises a control interface 704 for accepting user input to control the scaling. The user is offered the possibility of controlling one or more scaling factors. For example the user can control an additional scaling of foreground objects. That means that segments which correspond to foreground objects are enlarged more than image segments which are not classified as such. An advantage of this approach is that foreground objects are better visible. Besides that, it might result in a better image quality of the entire output image. This is in particular the case if interpolation of background pixels, to prevent the appearance of holes in the output image, would result in distortions of the background which exceed a predetermined level. This predetermined level is typically based on the spatial relation between input pixels to be used for the interpolation and the spatial relation between output pixels.

The segmentation unit 402, the scaling unit 404 and the tracking unit 702 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

In the examples as described in connection with FIG. 1, FIG. 2, FIG. 3, FIG. 5 and FIG. 6 the conversion was from an input aspect ratio of 4:3 into an output aspect ratio of 16:9. It will be clear that the method according to the invention and the conversion unit according to invention can also be applied for other input-output relations, e.g. from 16:9 to 4:3 or from 14:9 to 16:9.

Besides scaling in a first direction, in many cases a scaling in a second direction which is orthogonal to the first direction, is also required. It is preferred that a segment which is a scaled with a constant scaling factor in the first direction is also scaled with a constant scaling factor in the second direction. Preferably the scaling factors in the first and second direction are mutually equal. Scaling comprises enlargement and reduction. However a scaling with a unity factor, resulting in no change of size, is possible too.

The actual amount of enlargement or reduction in size of segments depend on a difference in the sizes of the input and output image. It will be clear that enlargement of an object with e.g. a factor of two can be realized by either a scaling with a constant factor or with a location dependent scaling factor. Hence, the actual enlargement of the first input segment being scaled with a first location dependent scaling factor can be equal to the actual enlargement of the second input segment being scaled with a constant scaling factor. The difference is the amount of deformation. Optionally, the actual enlargement of the first input segment and the actual enlargement of the second input segment are not mutually equal.

The segmentation is based on pixel values, i.e. on the actual image content. Optionally a part of the segmentation is performed externally, outside the image conversion unit. For example, a segmentation might have been performed by a broadcaster, e.g. in order to perform video compression. The method according to invention is in particular appropriate for combination with a segment based video compression scheme. While decoding the bitstream, the segments of the images are extracted. Also in that case the segmentation is based of pixel values. Some video compression standards e.g. MPEG-4 support the exchange of objects or layers. Preferably the foreground objects of the video stream are scaled with a constant scaling factor while background objects are scaled with a location dependent scaling factor.

FIG. 8 schematically shows an image display apparatus 800 according to the invention comprising:

a receiver 802 for receiving a sequence of images. The images may be broadcasted and received via an antenna or cable but may also come from a storage device like a VCR (Video Cassette Recorder) or DVD (Digital Versatile Disk). The aspect ratio of the images are conform a television standard, e.g. 4:3; 16:9 or 14:9;

an image conversion unit 804 implemented as described in connection with FIG. 4 or FIG. 7; and

a display device 806 for displaying images. The type of the display device 804 may be e.g. a CRT, LCD or PDP. The aspect ratio of the display device 806 is conform a television standard: 16:9.

The image conversion unit 804 performs an aspect ratio conversion of the images of the received sequence of images if the aspect ratio of these images does not correspond to the aspect ratio of the display device 806.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware. The usage of the words first, second and third, etcetera do not indicate any ordering. These words are to be interpreted as names.

1. An image conversion unit (400,700) for converting an input image with an input aspect ratio into an output image with an output aspect ratio being different from the input aspect ratio, the image conversion unit (400,700) comprising:
segmentation means (402) for segmentation of the input image on basis of pixel values of the input image, resulting in a first group of connected pixels forming a first input segment (310) which represents a first object and a second group of connected pixels forming a second input segment (306) which represents a second object; and
scaling means (404) for scaling the first input segment (310) in a first direction with a location dependent scaling factor into a first output segment (320) of the output image and for scaling the second input segment (306) in the first direction with a constant scaling factor into a second output segment (316) of the output image.

2. An image conversion unit (700) as claimed in claim 1, further comprising object tracking means (702) for tracking the second object by establishing that a further input segment in a further input image which belongs to a sequence of video images to which the input image also belongs, corresponds to the second input segment (306), and the scaling means being arranged to scale the further input segment into a further output segment with the constant scaling factor.

3. An image conversion unit (400,700) as claimed in claim 1, further comprising depth ordering means being arranged to establish a depth order between the first input segment (310) and the second input segment (306).

4. An image conversion unit (400,700) as claimed in claim 3, whereby the depth ordering means are based on one of a set of depth cues comprising: occlusion, relative image sharpness, color, size of segments.

5. An image conversion unit (400,700) as claimed in claim 1, comprising merging means for merging the first output segment (320) and the second output segment (316) resulting in overwriting a part of the pixel values of the first output segment (320) with pixel values of the second output segment (316).

6. An image conversion unit (700) as claimed in claim 1, comprising input means for accepting user input and scaling determining means for determining the constant scaling factor on basis of the user input.

7. An image conversion unit (400,700) as claimed in claim 1, whereby the input aspect ratio and the output aspect ratio are substantially equal to values of elements of the set of standard aspect ratios being used in television.

8. An image display apparatus (800) comprising:
a receiver (502) for receiving an input image;
an image conversion unit (804) as claimed in claim 1; and
a display device (806) for displaying the output image.

9. A method of converting an input image with an input aspect ratio into an output image with an output aspect ratio being different from the input aspect ratio, the method comprising:
segmentation of the input image on basis of pixel values of the input image, resulting in a first group of connected pixels forming a first input segment (310) which represents a first object and a second group of connected pixels forming a second input segment (306) which represents a second object; and
scaling the first input segment (310) in a first direction with a location dependent scaling factor into a first output segment (320) of the output image and for scaling the second input segment (306) in the first direction with a constant scaling factor into a second output segment (316) of the output image.

10. A computer program product to be loaded by a computer arrangement, comprising instructions to convert an input image with an input aspect ratio into an output image with an output aspect ratio being different from the input aspect ratio, the computer arrangement comprising processing means and a memory, the computer program product, after being loaded, providing said processing means with the capability to carry out:
segmentation of the input image on basis of pixel values of the input image, resulting in a first group of connected pixels forming a first input segment (310) which represents a first object and a second group of connected pixels forming a second input segment (306) which represents a second object; and
scaling the first input segment (310) in a first direction with a location dependent scaling factor into a first output segment (320) of the output image and for scaling the second input segment (306) in the first direction with a constant scaling factor into a second output segment (316) of the output image.
